(19) United States
(12) Patent Application Publication
(10) Pub. No.: US 2016/0231812 A1
(43) Pub. Date: Aug. 11, 2016

(54) MOBILE GAZE INPUT SYSTEM FOR PERVASIVE INTERACTION

(71) Applicant: The Eye Tribe Aps, Copenhagen (DK)

(72) Inventors: John Paulin Hansen, Roskilde (DK); Sebastian Sztuk, Copenhagen (DK); Javier San Agustin Lopez, Copenhagen (DK)

(21) Appl. No.: 15/017,820

(22) Filed: Feb. 8, 2016

Related U.S. Application Data
(60) Provisional application No. 62/112,837, filed on Feb. 6, 2015.

(51) Int. Cl. G06F 3/01; G06F 1/16

(52) U.S. Cl. CPC G06F 3/013; G06F 1/163

(57) ABSTRACT

A mobile gaze-tracking system is provided. The user operates the system by looking at the gaze tracking unit and at pre-defined regions at the fringe of the tracking unit. The gaze tracking unit may be placed on a smartwatch, a wristband, or woven into a sleeve of a garment. The unit provides feedback to the user in response to the received command input. The unit provides feedback to the user on how to position the mobile unit in front of his eyes. The gaze tracking unit interacts with one or more controlled devices via wireless or wired communications. Example devices include a lock, a thermostat, a light or a TV. The connection between the gaze tracking unit may be temporary or longer-lasting. The gaze tracking unit may detect features of the eye that provide information about the identity of the user.

### PRIORITY CLAIM

The application claims priority to U.S. Provisional Patent Application No. 62/112,837, filed Feb. 6, 2015, entitled “Mobile Gaze Input System for Pervasive Interaction,” which is incorporated herein by reference in its entirety.

TECHNICAL FIELD

The present disclosure generally relates to user interfaces and controls that utilize eye tracking and, more specifically, to systems and methods for controlling devices using a mobile eye-tracking sensor.

### BACKGROUND

A gaze of a user may be determined using eye tracking technology that determines the location of the user's gaze based on eye information present in images of the user's eyes or face.

### BRIEF DESCRIPTION OF THE DRAWINGS

Some example embodiments are illustrated by way of example and not of limitation in the figures of the accompanying drawings.

FIG. 1 is a device diagram of an example computing system capable of mobile gaze input for pervasive interaction, according to some example embodiments.

FIG. 2 is a block diagram of an example system architecture for a mobile gaze input system for pervasive interaction, according to some example embodiments.

FIG. 3 is a block diagram of an example flow of data used in a mobile gaze input system for pervasive interaction, according to some example embodiments.

FIG. 4 is a use case diagram showing communications and eye movements, according to some example embodiments.

FIG. 5 is a block diagram showing communications between devices implementing a mobile gaze input system for pervasive interaction, according to some example embodiments.

FIG. 6 is a use case diagram showing example user interfaces for a mobile gaze input system for pervasive interaction, according to some example embodiments.

FIG. 7 is a use case diagram showing additional example user interfaces for a mobile gaze input system for pervasive interaction, according to some example embodiments.

FIG. 8 is a use case diagram showing an additional example user interface for a mobile gaze input system for pervasive interaction, according to some example embodiments.

FIG. 9 is a use case diagram showing an additional example user interface for a mobile gaze input system for pervasive interaction, according to some example embodiments.

FIG. 10 is a use case diagram showing an example user interface for a mobile gaze input system on a wearable device for pervasive interaction, according to sonic example embodiments.

FIG. 11 is a use case diagram showing an additional example user interface for a mobile gaze input system on a wearable device for pervasive interaction, according to some example embodiments.

FIG. 12 is a use case diagram showing an additional example user interface for a mobile gaze input system on multiple wearable devices for pervasive interaction, according to some example embodiments.

FIG. 13 is a use case diagram showing an additional example user interface for a mobile gaze input system on a wearable device for pervasive interaction, according to some example embodiments.

FIG. 14 is a use case diagram showing additional example user interfaces for a mobile gaze input system for pervasive interaction, according to some example embodiments.

FIG. 15 is a use case diagram showing additional example user interfaces for a mobile gaze input system for pervasive interaction, according to some example embodiments.

FIG. 16 is a use case diagram showing additional example user interfaces for a mobile gaze input system for pervasive interaction, according to some example embodiments.

FIG. 17 is a use case diagram showing additional example user interfaces for a mobile gaze input system for pervasive interaction, according to some example embodiments.

FIG. 18 is a block diagram of a machine in the example form of a computer system within which a set of instructions, for causing the machine to perform any one or more of the methodologies discussed herein, may be executed, according to some example embodiments.

### DETAILED DESCRIPTION

Example systems and methods for a mobile gaze input system for pervasive interaction are described. In the following description, for purposes of explanation, numerous specific details are set forth in order to provide a thorough understanding of example embodiments. It will be evident, however, to one skilled in the art, that the present technology may be practiced without these specific details. In the present context, pervasive interaction refers to the use of an eye-tracking controller that moves with the user rather than having a fixed association with a particular device being controlled.

In some example embodiments, the user operates the system by looking at the gaze tracking unit and at pre-defined regions at the fringe of the tracking unit. The gaze tracking unit may be placed on a smartwatch, a wristband, or woven into a sleeve of a garment. In some example embodiments, the unit provides feedback to the user in response to the received command input. The unit may also continuously provide feedback to the user on how to position the mobile unit in front of his eyes. In some example embodiments, the mobile gaze input system is used for security management.

The gaze tracking unit interacts with one or more controlled devices via wireless or wired communications e.g., Bluetooth, WiFi, or a physical cable). Example devices include a lock (e.g., on a door to a car, on a door to a building, on a bike, or on a gate), a thermostat, or an appliance (e.g., a TV, a DVR, a stereo, or a refrigerator). The connection between the gaze tracking unit may be temporary (e.g., based on proximity-sensing) or longer-lasting (e.g., using IP addresses or cable connections).

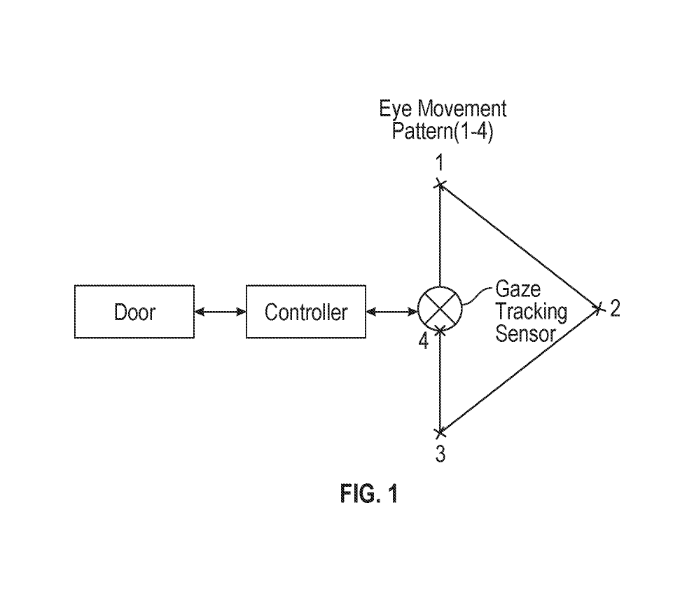

FIG. 1 is a device diagram of an example computing system capable of implementing a mobile gaze input system for pervasive interaction, according to some example embodiments. FIG. 1 shows a controller and a door to be opened. The controller may be any type of mobile computing device, including, but not limited to, a smart phone, a personal digital assistant (PDA), a mobile phone, a computing tablet, an electronic reader, a head-mounted display, a smart watch, a wristband, a smart ring, and the like. During eye tracking control, the controller may be used by the user by holding the controller with one hand, both hands, or while the controller is on a stand, resting on a surface, or affixed to the user.

The controller may include a camera and one or more light-emitting diodes (LEDs). The eye tracking control software analyzes the images taken by the camera to detect the direction of the user's gaze relative to the controller. The detected direction may be used for any number of applications (e.g., scrolling, moving objects, selecting icons, unlocking doors, adjusting a thermostat, etc.). In some example embodiments, the degree to which the user's gaze is directed in the detected direction is also measured. For example, not just that the user is looking “up,” but that the user is looking “slightly up,” “somewhat up,” or “fully up.” The degree may be quantified (e.g., with three degrees for each direction or ten degrees for each direction).

In the example embodiment of FIG. 1, the user looks at the mobile gaze tracking sensor to initiate communication between the controller and the door. For example, the user looks at his smart watch, which then enables Bluetooth pairing. The door, sensing a nearby Bluetooth device, connects to the smart watch. The smart watch and the door communicate their various features, and the smart watch becomes registered with the door as a device capable of transmitting an unlock code to the door. In some example embodiments, the smart watch is pre-registered with the door as a trusted device and untrusted devices are not accepted by the door as valid sources of unlock codes. In some example embodiments, a particular eye-movement pattern is required by the controller to enable communication with the door. In some example embodiments, the user initiates communication between the controller and the door by using another input modality, such as a voice command, a tap on the device, a swipe on a touchscreen, or any suitable combination thereof.

The user moves his eyes around the unit in a predefined pattern. FIG. 1 shows an example of a four-step pattern being used. The detected gaze directions are transmitted from the controller to the door. The door recognizes that the sequence of movements correspond to the predetermined unlock sequence, and releases the lock, allowing the user to enter. This may provide increased security over a PIN-pad (e.g., for use in an automatic teller machine (ATM)), since it may be more difficult for an interloper to copy the sequence of eye movements than to determine which keys were pressed. Additionally, when the controller is carried or worn by the user, it may be more difficult for an interloper to even attempt to enter the door code.

Security may further be increased by combination of the eye tracker with one or more of: detection of the iris, detection of individual eye movement patterns, detection of pupil dilation patterns, including dilation provoked by light stimuli from lights controlled by the eye tracker, a regular pattern of eye movement associated with the user, a particular set of voluntary hand movements that the user conducts with the gaze tracking unit activated, a voice-entered password, matching an image or video of the user with a reference, detection of a radio-frequency identifier (RFID) device associated with the user, and detection of a distance between the eye tracker and the device being controlled. For example, by recognizing the user's iris pattern, the gaze tracking unit can determine whether or not the user corresponds to the entered eye-movement pattern.

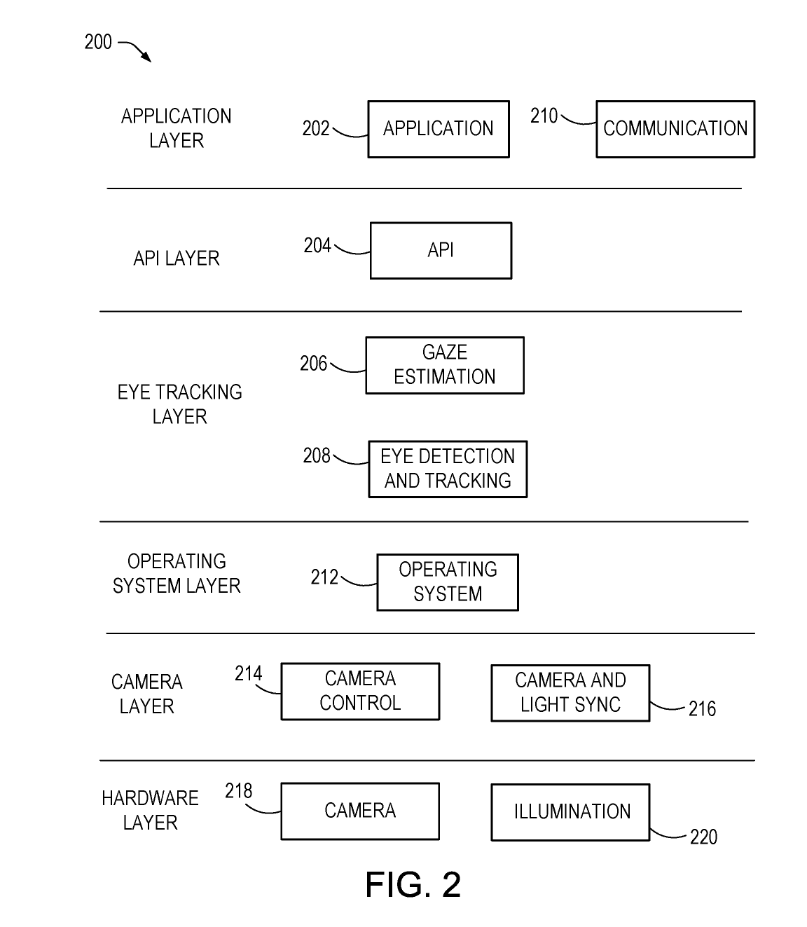

FIG. 2 is a block diagram of an example system architecture 200 for facilitating eye tracking control. Any one or more of the components 202-220 of the system architecture 200 may be implemented using hardware modules e.g., a properly-configured central processing unit (CPU) of the computing device or a combination of a CPU and a graphics processing unit (GPU) of the computing device). In some example embodiments, any one or more of the components 202-220 of the system architecture 200 may include software running on a dedicated chip. The software may run as a background process (e.g. as part of the operating system (OS), in a web browser, etc.) and may provide an application programming interface (API) 204 that other applications can access. The communication module 210 sends data to and receives data from other devices. For example, the communication module 210 may be implemented using wired or wireless networking protocols. The API 204 may send an alert (e.g., raise an event) or use some other similar mechanism to send the gaze information to other applications.

The system architecture 200 may be divided into different layers. The hardware layer may include a camera module 218 and an illumination module 220 that may correspond to the respective hardware (e.g. the camera, infrared illumination, etc.). A camera layer may include a camera control module 214 that may be in charge of communicating with the one or more cameras in order to perform camera operations such as, for example, starting the camera, grabbing images, controlling the camera properties, and the like. This layer may also include a camera and light sync module 216, which may synchronize the one or more cameras and the infrared emitters so that the lights are turned on by the eye tracking software in order to improve tracking of the user's eyes and minimize energy consumption. In some example embodiments, the camera layer may be configured to strobe the infrared LEDs at the frequency of the camera trigger output.

The camera layer may deliver images to the eye tracking layer. In the eye tracking layer, an eye detection and tracking module 208 may process images to find features like face location, eye region location, pupil center, pupil size, location of the corneal reflections, eye corners, iris center, iris size, and the like. Furthermore, these features may be used by the gaze estimation module 206 in the gaze estimation stage, which may be in charge of calculating the point of regard or the line of sight of the user using the features computed by the eye detection and tracking module 208. The point of regard of the user may be a location on the display where the user is looking, a location on another plane where the user is looking, a three-dimensional point where the user is looking, or a plane where the user is looking. The gaze estimation module 206 may also calculate specific features of the user's eyes, such as optical and visual axes, locations of the cornea center and pupil in 3D space, etc. These features may also he employed to compute the point of regard on a given display or plane. The eye detection and tracking engine may start, stop and pause the camera depending on actions performed by the user, such as a movement of the hand wearing the mobile gaze tracking unit. These movements may be captured by a motion sensor equipped on the device e.g., on the smart watch or the gaze tracking unit itself).

The API layer may be used for communication between the eye tracking layer and applications 202 that use eye gaze information (e.g., the operating system (OS) layer or games that employ eye gaze information). Though the OS 212 is shown in FIG. 2 as intermediating between the eye tracking layer and the hardware layer, in some example embodiments, the relative positions are reversed and the eye tracking layer intermediates between the OS 212 and the camera layer. An API module 204 may send data calculated by the eye tracking layer, such as coordinates of the point of regard, 3-D location of the user's eyes, pupil size, distance between the eyes, head orientation, head movement, and the like. The API module 204 may also accept commands from an application to the eye tracking layer (e.g., to start or stop the eye tracking engine, query for specific information, inform the engine of the location and size of visual elements the user may look at, or any suitable combination thereof). An application module 202 and the OS 212 may connect to the eye tracker's API module 204 and use eye gaze information for any suitable purpose (e.g., control an application or a game, record eye data for visual behavior studies, adjust the transparency of information on a screen, or any suitable combination thereof).

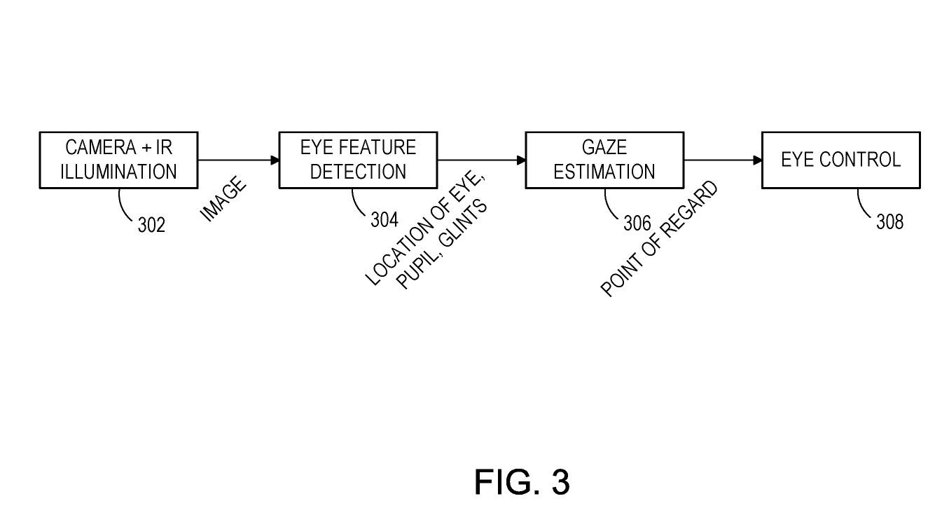

FIG. 3 is a block diagram of an example flow of data used to facilitate eye tracking control. The camera and infrared illumination module 302 may capture an image of the user (e.g., take a photograph of the user's head or face) using one or more cameras, ambient light, emitted visible light, emitted infrared light, or any suitable combination thereof. The eye feature detection module 304 may use the captured image data to detect eye features e.g., location and orientation of eyes, pupils, irises, corneal reflections, or any suitable combination thereof). Using the detected eye features, the gaze estimation module 306 may estimate the user's point of regard or line of sight, which may then be used to control aspects of an application through the eye control module 308.

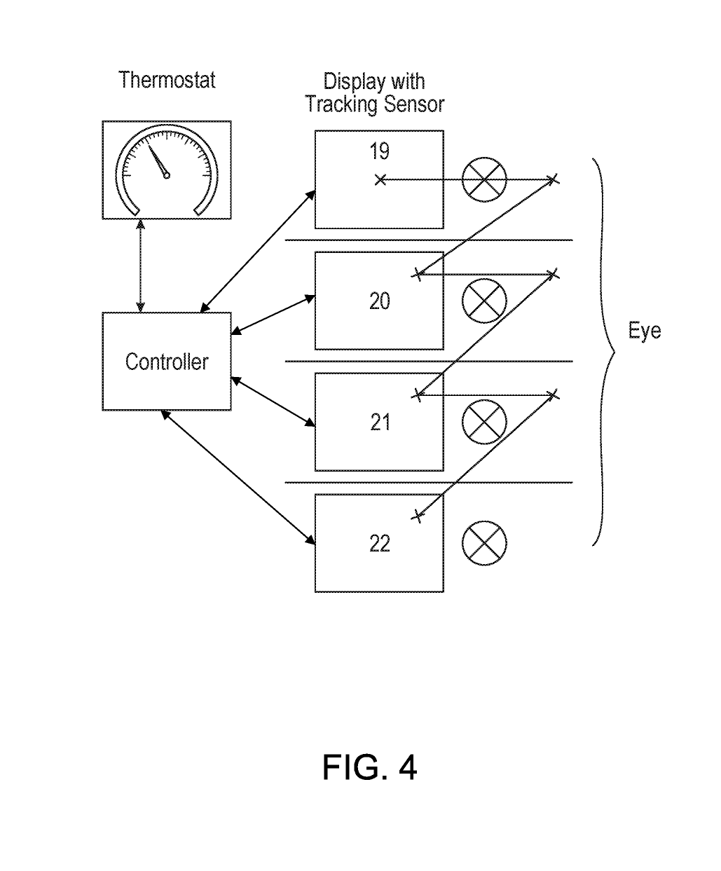

FIG. 4 is a use case diagram showing communications and eye movements, according to some example embodiments. FIG. 4 shows a controller and a thermostat to be controlled along with a sequence of three commands. The controller connects to the thermostat. For example, near-field communications may be used and the controller and thermostat connect to each other once they are within a certain proximity. Initially, in step 1, the thermostat is set to 19 degrees C. The temperature of the thermostat may be displayed on the thermostat, on a display of the controller, or any suitable combination thereof. The user looks to the right of the controller and back to the center, triggering an increase of 1 degree in the thermostat. This process is repeated two more times, until, in step 4, the thermostat is set to 22 degrees. Similar controls can be used to control the intensity of a light, the volume of a music player, to select a channel or input source for a TV or game system, and to control other appliances.

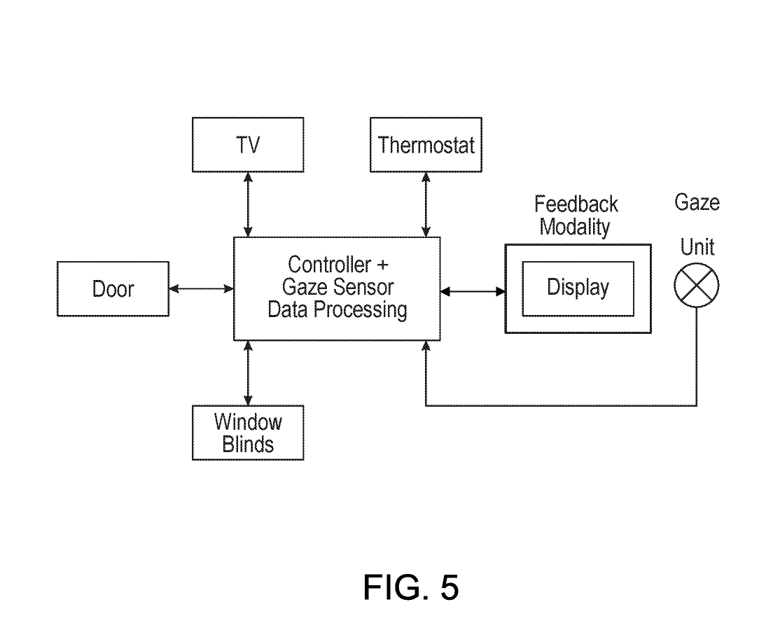

FIG. 5 is a block diagram showing communications between devices implementing a mobile gaze input system for pervasive interaction, according to some example embodiments. In an example embodiment, the controller includes a small display. The display may be suitable for displaying a few words of text at a time, allowing the user to read the text. However, the display may be too small to display large images. Accordingly, the controller may he paired with a larger display device (e.g., a monitor, tablet, or TV). A point in the text is associated with an image (e.g., an image anchor point in a text or HTML document). When the text reaches that point, the larger display device displays the associated image. The system may be temporarily configured (e.g., programmed) so that the image will only be shown at the larger display if the mobile gaze tracking unit, or another gaze tracking unit in the room (for instance located with the larger display) that is connected to the mobile gaze tracking unit, detects that the user is actually looking at the larger display. The image may be transmitted to the larger display device from the controller. Alternatively, a location of the image (e.g., a uniform resource locator (URL)) is sent to the larger display device from the controller and the larger display device retrieves the image for display from the location.

In a use case of this embodiment, a user walks from room to room within a house or office, reading on his smart watch. In each room, a display device is mounted. As the user walks from room to room, the display device in that room displays the image associated with the current portion of the text the user is reading. For example, a location sensor in the controller may determine which display is closest the user. As another example, a communication protocol (e.g., Bluetooth or near-field communication) may limit the controller to being paired to one display at a time. Accordingly, when the controller comes within range of a first display, the display pairs with the controller. When the controller leaves the range of the first display, the controller pairs with another display that is in-range. By adjusting the range of each display and controlling their relative positions, the desired functionality is obtained.

A correspondence between the spatial location of the unit in the room and the displays or appliances can be made if the smartwatch knows its orientation towards each displays or appliances. If the user looks consistently in one direction, the unit may automatically lock on to the closest device in that direction for activation.

In controllers including a display, the display can provide guidance and feedback for ease of the remote controlling. An invisible grid is defined in the fringe of the mobile gaze tracker, and when the user looks through this grid in a certain way, it will make an input. There are four types of gaze inputs:

1) Look-away. This is an on-screen to off-screen gaze movement.

2) Dwell-time activation, The user looks at a particular region of the grid for a predetermined period of time.

3) Gesture activation. The user looks through two or more grid regions in a predetermined order.

4) Pursuit activation. The user focuses on a particular grid region while smoothly moving the tracking unit and keeping the head still. The smooth motion of a tracker can be detected by motion sensors (e.g. gyroscope), and by the gaze sensor as unique smooth pursuit eye movements.

In some example embodiments, the controller includes region target markers. The region target markers may improve usability for novice users. The region target markers can be part of the tracking unit itself, for instance LEDs mounted on the strap of it, or a dot-mark on the sleeve. They can be concurrent markers, for instance a finger ring, or they can be dynamically positioned markers from the natural environment, placed ad-hoc by the user within a target region by holding the unit next to the object that serves as a temporary marker. For instance, a light may be switched on by holding the tracking unit in a position that makes the gaze traverse the particular control region for “turn on” when looking at it. As another example, alight dimmer may be controlled to dim or brighten a light by holding the tracking unit in a position that makes the gaze traverse the particular control region for “dim” or “brighten” when looking at it.

FIG. 5 shows an example embodiment in which there is more than one object connected to the tracking unit. In this example embodiment, an output unit (e.g. a display) to inform the user which of the objects he is currently engaging with is included. The display may in itself be regarded as an object for control (i.e. the master output unit). The controller provides the master display and processes the gaze sensor data. Alternatively, the master output unit may he mounted at a fixed location, and when the user positions a tracking unit in the proximity of it, the master output unit may then take over. For example, a night guard entering a room may walk up to a display, put his mobile gaze tracker next to it, and conduct series of gaze movements, in order to turn off the TV, close the blinds, and finally turn off the lights in that room.

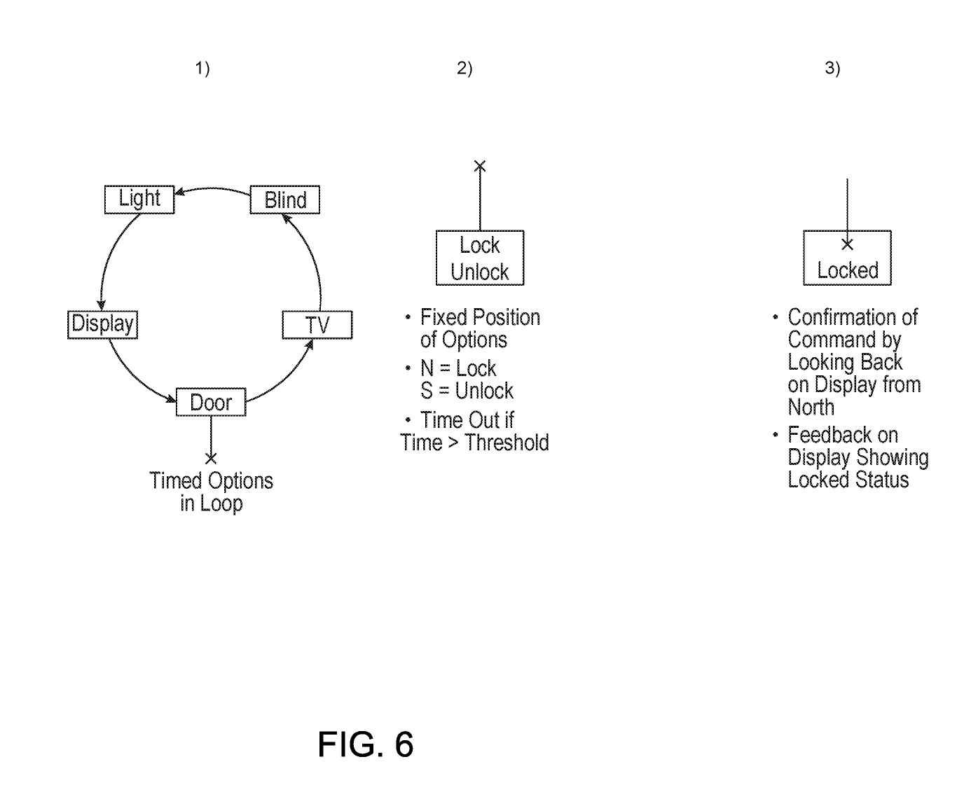

FIG. 6 is a use case diagram showing example user interfaces for mobile gaze input system for pervasive interaction, according to some example embodiments. In some example embodiments, the wearable device provides a set of multiple control options using temporal sequencing. For example, control of TV, doors, window blinds and lights that are all connected to the unit, may be displayed in a looping serial order, as shown in portion 1 of FIG. 6. If the user would like to control the doors, for instance, he looks through one of the predefined grid regions immediately when this option is shown on the display, and then back to the display again (e.g., a gaze gesture to the north). This would select “doors” to be controlled, and now the interface, as shown in portion 2 of FIG. 6, shows two new options: “lock” at the top and “unlock” at the bottom. With yet another gaze gesture to the north he would then lock the door. A confirmation may be displayed, as shown in portion 3 of FIG. 6. If no gaze inputs are recognized within a predefined timeout, the interface will return to basic mode, showing the sequence of connected devices again, as displayed in portion 1 of FIG. 6. The control options may be provided by text, by sound, by vibration, by image, or any suitable combination thereof.

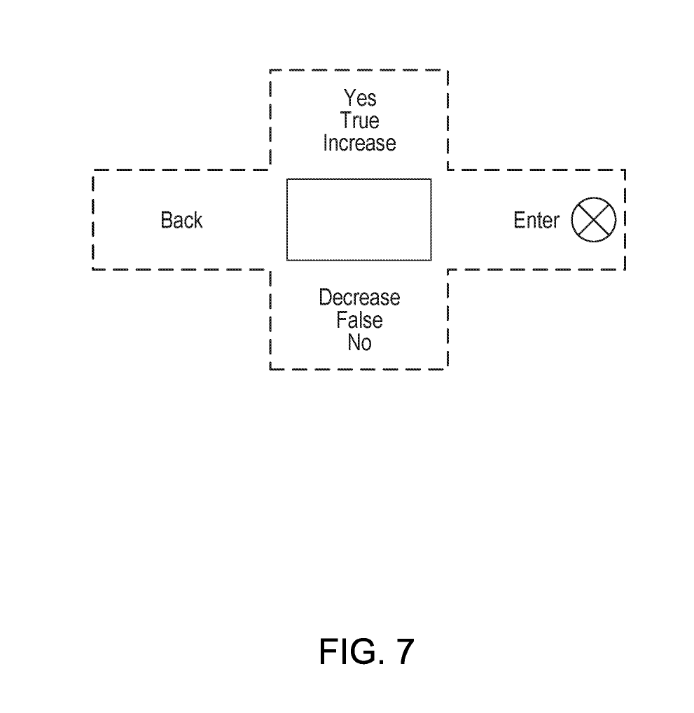

FIG. 7 is a use case diagram showing example user interfaces for a mobile gaze input system for pervasive interaction, according to some example embodiments. In some example embodiments, standard eye movement command patterns are used across a number of interactive control options. The use of standard eye movement command patterns may serve to reduce the cognitive load on users. In one example embodiment, the basic mapping shown in FIG. 7 is used. In this mapping, an upward gesture means increase, true, or yes; a downward gesture means decrease, false, or no; a leftward gesture means “go back” in a menu, text, or command structure; and a rightward gesture means “enter” or execute. Different commands for the shown gestures may be used, and additional gestures may be used. In some example embodiments, a display of the device shows the commands and their associated gestures. In some example embodiments, computational power, time, or both are saved by calculating the direction and region of the user's gaze without determining a particular focal point. In some example embodiments, one or more locations are excluded from triggering a command. This allows a user to have safe fixation points that will not activate the device. In some example embodiments, the user may confirm selections or navigate the menu by using other input modalities such as voice recognition, a touchscreen, a button, etc.

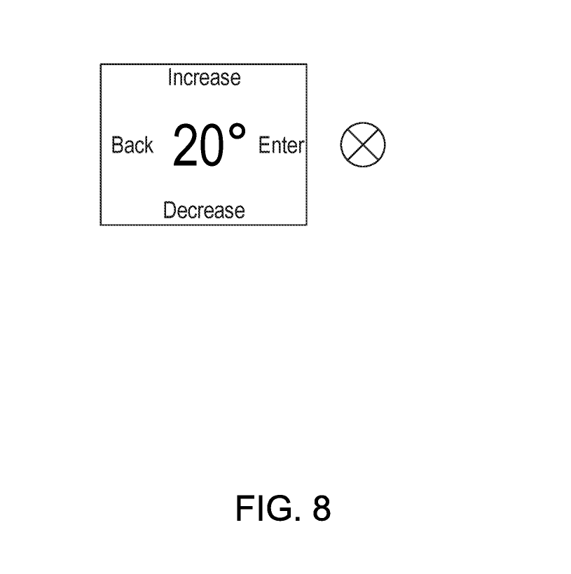

FIG. 8 is a use case diagram showing an example user interface for a mobile gaze input system for pervasive interaction, according to some example embodiments. FIG. 8 shows an example display of a wearable device, wherein the center of the display contains information regarding a device being controlled by the user. In this example, the display shows that the current target temperature for a controlled thermostat is 20 degrees. The display further shows that a gesture up will increase the target temperature of the thermostat, a gesture down will decrease the target temperature of the thermostat, a gesture left will move back through the menu options, and a gesture right will confirm that the currently-displayed temperature should be used by the thermostat.

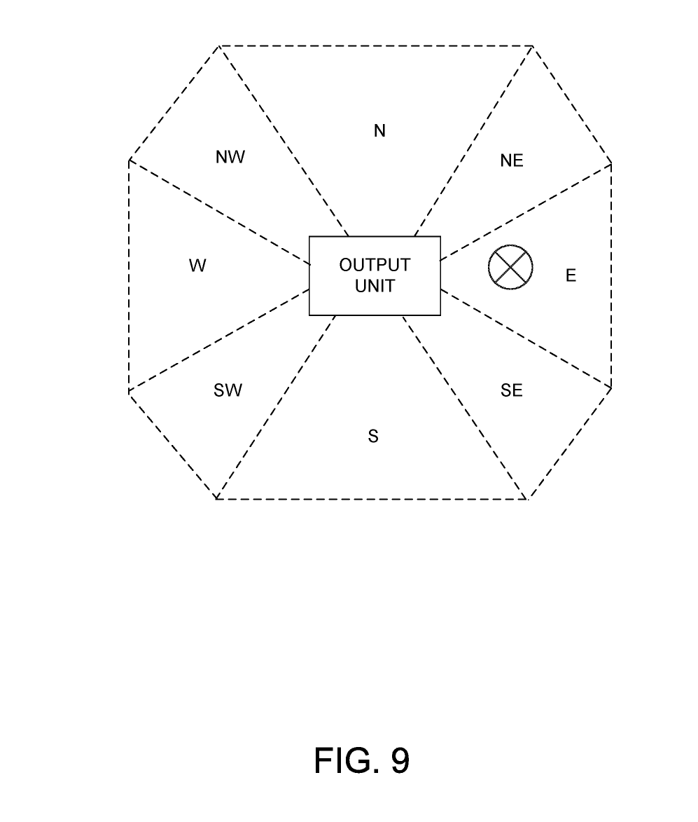

FIG. 9 is a use case diagram showing an example user interface for mobile gaze input system for pervasive interaction, according to some example embodiments. In the example of FIG. 9, the number of control regions has been increased from four to 8. In other example embodiments, more or fewer control regions are used. The grid layout may be completely invisible or may be shown on a display of the mobile device, or by other means, for instance light patterns projected from the mobile device. One or more gesture controls may be assigned to control the display of information on the display of the mobile device.

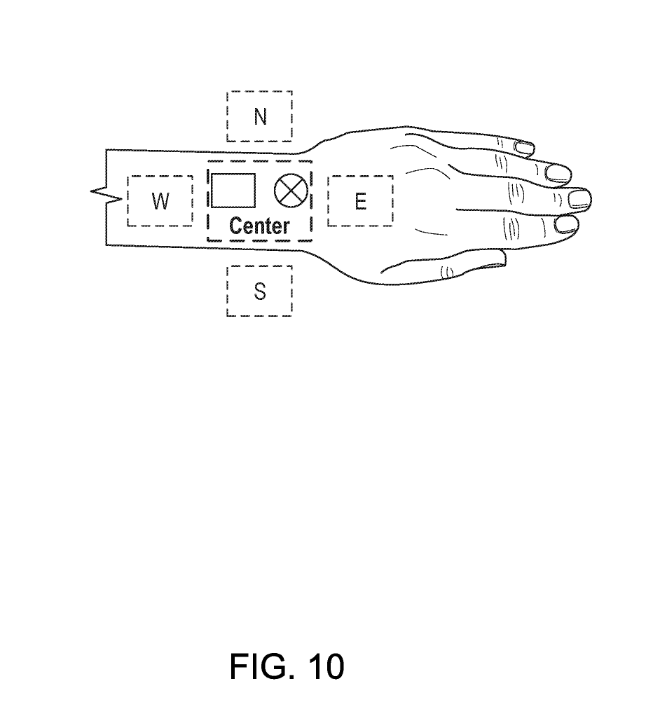

FIG. 10 is a use case diagram showing an example user interface for a mobile gaze input system on a wearable device for pervasive interaction, according to some example embodiments. As can be seen in FIG. 10, the four control regions correspond to the back of the hand, the forearm, above the arm, and below the arm, when the control device is wrist-mounted.

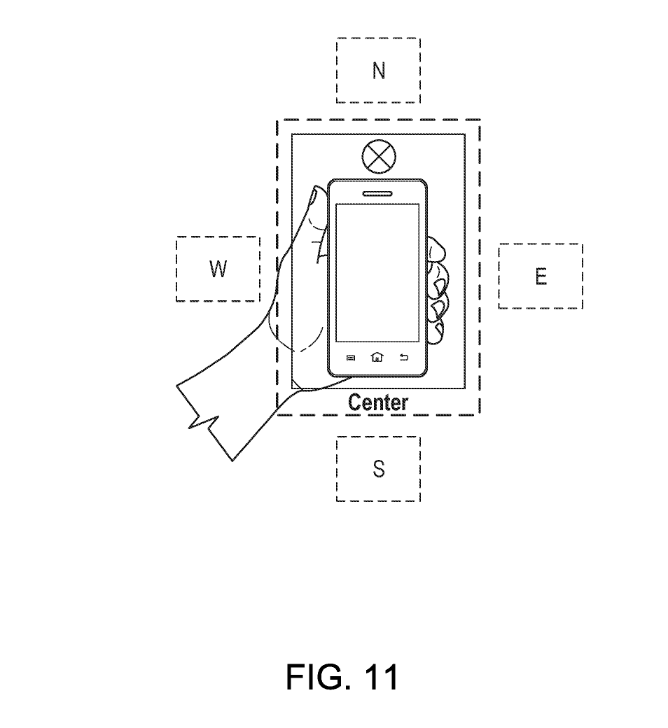

FIG. 11 is a use case diagram showing an example user interface for mobile gaze input system on a wearable device for pervasive interaction, according to some example embodiments. As can be seen in FIG. 11, the four control regions correspond to the wrist and three areas in space, when the control device is hand-held. In some example embodiments, the North, South, West, and East gaze directions are used as joystick-style controls to control a display device. For example, a subway system or amusement park may have interactive video maps displayed throughout the system or park. Upon approaching a map, the user's device can connect to the map. The user can then use eye controls to scroll around the map. The display device controlled by this joystick-style control may also be a display that is part of the mobile gaze input system, for instance a smart watch or a mobile phone.

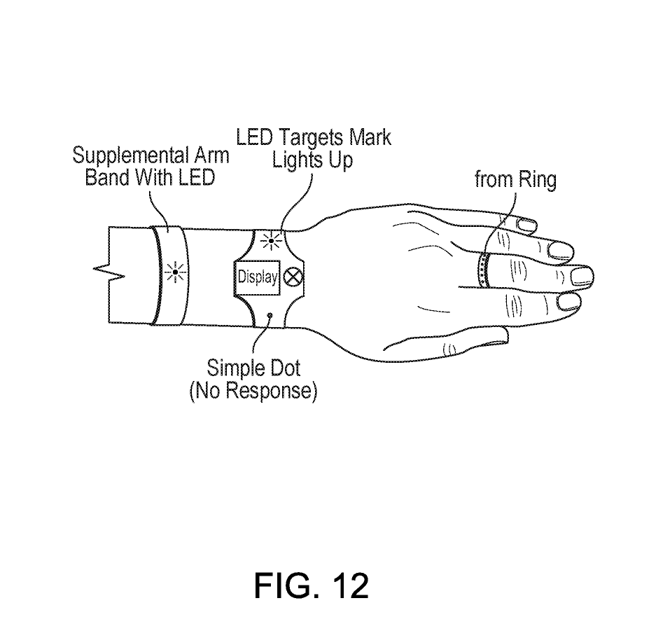

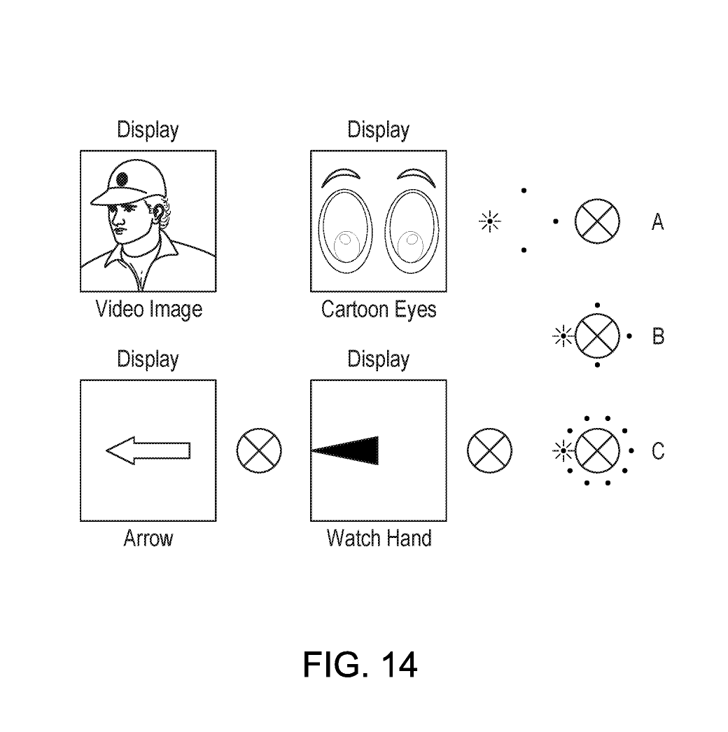

FIG. 12 is a use case diagram showing an example user interface for mobile gaze input system on multiple wearable devices for pervasive interaction, according to some example embodiments. In some example embodiments, one or more wearable devices provide a visual, tactile or audible feedback, in response to activation by the user of the gaze unit and one of the target locations. FIG. 14, discussed below, shows some examples of visual feedback, for instance blinking, flashing a large symbol (e.g. “N” when the northern area is hit), or changing a color. The flashing symbol may also be related to the device currently controlled (e.g. showing the new temperature of the thermostat in FIG. 8). Feedback may also be provided through vibration (e.g., a mobile phone could vibrate in distinctive ways for each of the target areas when hit), audio confirmation (e.g., say “North” when an upward gesture is detected), or both.

Target indicators may be shown on a wearable device as well. For example, target indicators may be shown on the strap holding a wrist-mounted tracking unit, on a finger ring, on an arm band, or any suitable combination thereof. The finger ring could in itself provide feedback (e.g., tactile or visual feedback) if connected to the wrist-mounted tracker. In some example embodiments, natural targets are used (e.g., the user's thumb).

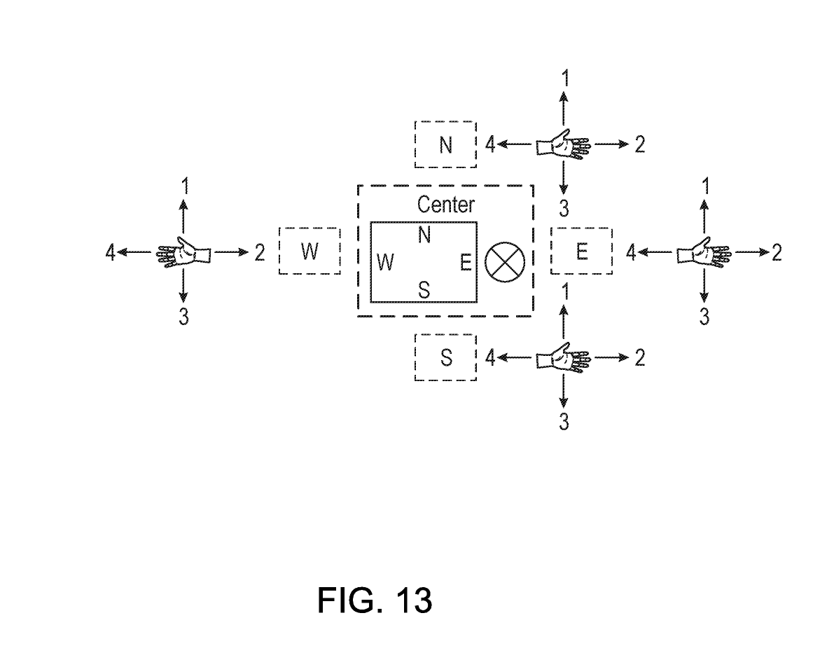

FIG. 13 is a use case diagram showing an example user interface for mobile gaze input system on a wearable device for pervasive interaction, according to some example embodiments, The combination of target areas and smooth hand movements multiplies the interaction principles. For instance, the user could enter a room where his gaze tracking unit would get connection with four intelligent devices: the door lock, the light, the thermostat and the window blinds. Looking to the north of the gaze tracking unit would activate the door lock. Then moving the unit slowly to the right (east) while keeping looking through the north region or at the unit itself‥while holding the head still‥would lock the door. Moving it to the left would unlock it. FIG. 13 shows how 4 gaze movement directions multiplied with 4 hand movement directions provide 16 interaction possibilities.

FIG. 14 is a use case diagram showing example user interfaces for mobile gaze input system for pervasive interaction, according to some example embodiments. In some example embodiments, the mobile device provides feedback on how to position the tracking unit to make sure the user's eyes remains within the tracking window. The tracking window is the region within which the device can detect the trackable features of the user's eye.

In some example embodiments, feedback is provided in 3 ways. First, if the sensor successfully detects one or two human eyes for a certain predetermined time, the mobile device lights up, changes a foreground or background color, emits a sound, vibrates, or any suitable combination thereof. Second, if the sensor is unable to start eve tracking, an indicator of the direction the user should move the tracking unit to place it in proper position to capture eye data is shown. The indicator may be shown visually by LED lights around the sensor (as shown in portions a, b, and c of FIG. 14), on a display (e.g., the four portions labeled “display” of FIG. 14), by audio (e.g., 3D sound), vibration, a spotlight or other types of light projections pointing in the direction to move the unit, or any suitable combination thereof. In embodiments in which the mobile device is a head-mounted display, the indicator may be shown as overlaid information from the tracking unit into the environment. In some example embodiments, the indicators may be activated or deactivated according to a user control. The size, location, color, and brightness of the indicators may be selected such that the indicator is visible using the peripheral vision of the user.

Third, when good tracking is achieved, information related to the control may be presented, either on the display or by any other output device connected to the tracking unit. The direction indicator may still be visible, unless the user turns it off by a specific command. The achieved information may also be presented with a warning that good gaze tracking is not achieved, and some other input method should be used instead.

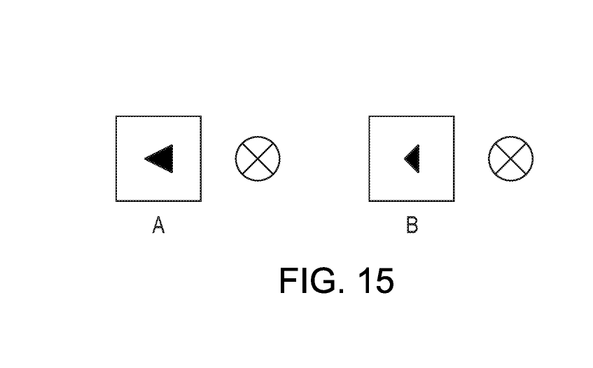

FIG. 15 is a use case diagram showing example user interfaces for mobile gaze input system for pervasive interaction, according to some example embodiments. FIG. 15 shows additional example indicators to guide the user. The example indicators of FIG. 15 show both the direction and the distance to move the unit. This is done by a relative length of an arrow or hand. Thus, the indicator (A) shows the user to move the tracking unit far to the left and the indicator (B) shows to move it a short distance.

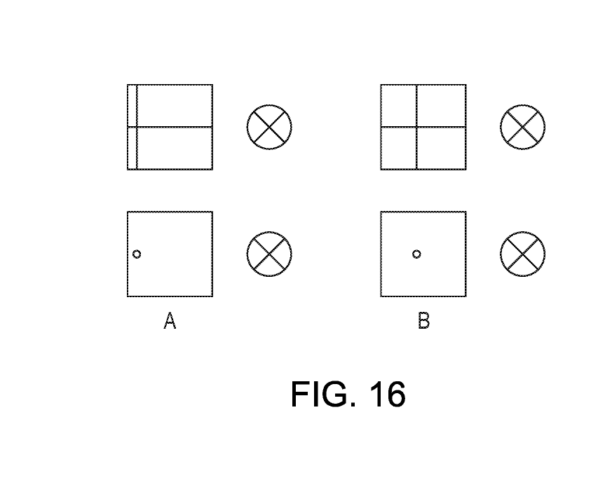

FIG. 16 is a use case diagram showing example user interfaces for mobile gaze input system for pervasive interaction, according to some example embodiments. FIG. 16 shows additional example indicators to guide the user. The example indicators of FIG. 16 show a single point telling where to move the tracking unit with reference to the center of the unit. Thus, the indicator (A) shows the user to move the tracking unit far to the left, the indicator (B) shows to move a short distance.

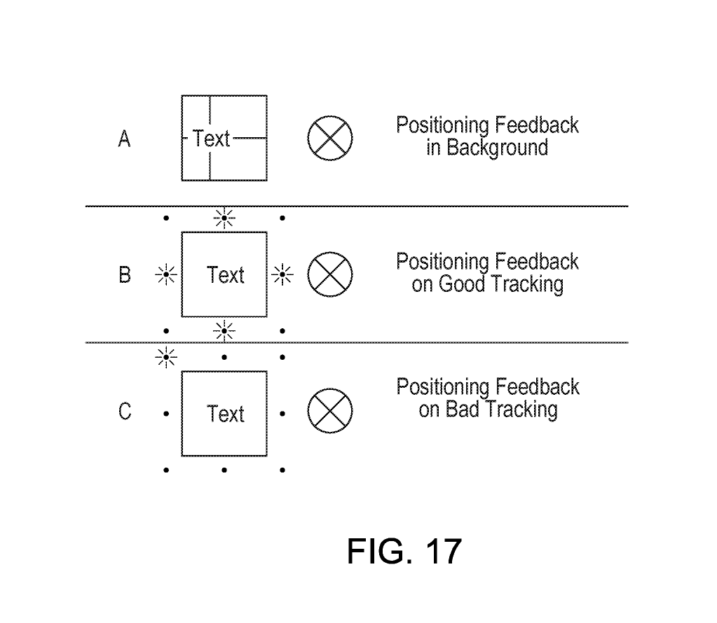

FIG. 17 is a use case diagram showing example user interfaces for a mobile gaze input system for pervasive interaction, according to some example embodiments. FIG. 17 shows examples of how the indicators can be combined with the control interface. Portion (A) shows how a graphical indicator (e.g., a cross-hair) can be in the background of a display. Portions (B) and (C) show how limited indicators may be used to provide directions on how to position the unit. Portion (B) shows four lit lights surrounding the display, indicating a good tracking condition. Portion (C) shows one lit light, indicating that the tracking device should be moved toward (or away from, in some example embodiments) the lit light. The indicators can also be positioned around the tracking sensor itself (e.g., when there is no display unit).

Besides remote control of the environment, the gaze commands may be used to control the display itself, for instance to adjust the speed by which the control options are shown. A particular region, for instance to the east of the gaze tracking unit, may be reserved for a “back” command which would bring the user up one level, in case the user regrets the path taken down the menu, or would like to get access to a higher level option.

The methods and systems described herein may provide advantages over existing methods and systems. This approach is different from previous concepts of gaze-controlled environments, in which the system to be controlled also provides gaze-detection features. The methods and systems described herein do not need to know the precise location of the device being controlled.

Certain example embodiments are described herein as including logic or a number of components, modules, or mechanisms. Modules may constitute hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various example embodiments, a hardware module may be implemented mechanically or electronically. For example, a hardware module may comprise dedicated circuitry or logic that is permanently configured (e.g., as a special-purpose processor, such as afield programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other example embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In example embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

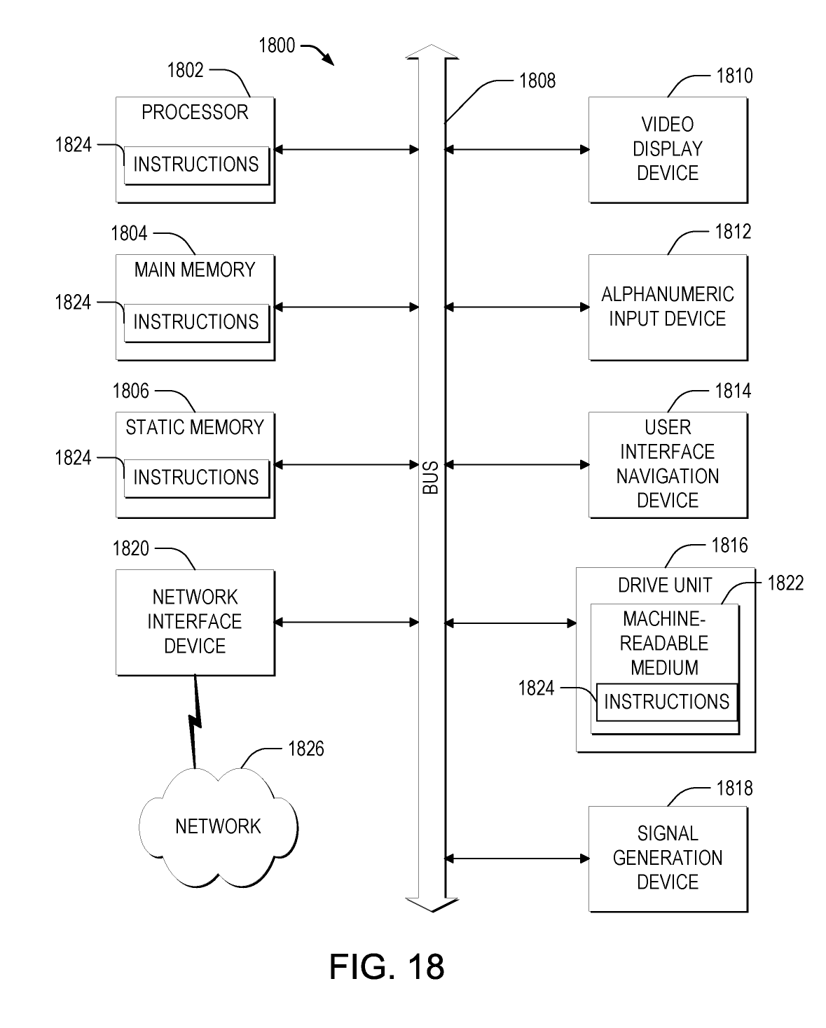

FIG. 18 is a block diagram of a machine in the example form of a computer system 1800 within which instructions, for causing the machine to perform any one or more of the methodologies discussed herein, may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1800 includes a processor 1802 (e.g., a CPU, a GPU, or both), a main memory 1804, and a static memory 1806, which communicate with each other via a bus 1808. Computer system 1800 may further include a video display device 1810 (e.g., a liquid crystal display (LCD) or a cathode ray tube (CRT)). Computer system 1800 also includes an alphanumeric input device 1812 (e.g., a keyboard), a user interface (UI) navigation device 1814 (e.g., a mouse or touch sensitive display), a disk drive unit 1816, a signal generation device 1818 (e.g., a speaker), and a network interface device 1820.

Disk drive unit 1816 includes a machine-readable medium 1822 on which is stored one or more sets of instructions and data structures (e.g., software) 1824 embodying or utilized by any one or more of the methodologies or functions described herein. Instructions 1824 may also reside, completely or at least partially, within main memory 1804, within static memory 1806, or within processor 1802 during execution thereof by computer system 1800, with main memory 1804 and processor 1802 also constituting machine-readable media.

While machine-readable medium 1822 is shown in an example embodiment to be a single medium, the term “machine-readable medium” may include a single medium or multiple media (e.g., a centralized or distributed database, or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present technology, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

Instructions 1824 may further be transmitted or received over a communications network 1826 using a transmission medium. Instructions 1824 may be transmitted using network interface device 1820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The example embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
detecting, by a mobile device, a device to be controlled;
connecting the mobile device to the device to be controlled over a wireless connection;
detecting, by the mobile device, a gaze input; and
transmitting the gaze input to the device to be controlled.

2. The method of claim 1, wherein:
the gaze input is one of a plurality of gaze inputs;
the device to be controlled is a door; and
the method further comprises:
receiving, by the device to be controlled, the plurality of gaze inputs;
comparing, by the device to be controlled, the plurality of gaze inputs
to a predetermined series of gaze inputs; and
based on the plurality of gaze inputs matching the predetermined series of gaze inputs, unlocking the door.

3. The method of claim 1, wherein the device to be controlled is a thermostat; and
the method further comprises:
receiving, by the thermostat, the gaze input; and
in response to receiving the gaze input, changing a temperature of the thermostat.

4. The method of claim 1, further comprising:
receiving, by the mobile device, data from the device to be controlled; and
presenting, on a display of the mobile device, the received data.

5. The method of claim 1, wherein the gaze input is in a direction and includes a degree in the direction.

6 The method of claim 1, wherein the mobile device is a wearable device.

7. The method of claim 6, wherein:
the wearable device is worn on a wrist of a user; and
the gaze input corresponds to a control region selected from the group consisting of a back of a hand, a forearm, above an arm, and below the arm.

8. The method of claim 1, further comprising:
prior to the connecting of the mobile device to the device to be controlled over the wireless connection, detecting, by the mobile device, an initial gaze input; and wherein
the connecting of the mobile device to the device to be controlled is in response to the detection of the initial gaze input.

9. The method of claim 1, wherein the gaze input is selected from the group consisting of: a look-away input, a dwell-time activation input, a gesture activation input, and a pursuit activation input.

10. The method of claim 1, further comprising:
connecting the mobile device to a second device including a display; and
causing presentation on the display of information regarding the device to be controlled.

11. The method of claim 1, further comprising:
providing, on the mobile device, visual feedback to the receiving of the gaze input.

12. The method of claim 11, wherein the visual feedback comprises a directional indicator based on the gaze input.

13. The method of claim 11, wherein the visual feedback comprises a distance indicator based on the gaze input.

14. The method of claim 1, further comprising:
providing, on the mobile device vibration feedback to the receiving of the gaze input.

15. The method of claim 1, further comprising:
providing, on the mobile device, audio feedback to the receiving of the gaze input.

16. A system comprising:
a memory storing instructions;
a display; and
one or more processors configured by the instructions to perform operations comprising:
connecting to a device to be controlled;
receiving data from the device to be controlled;
displaying the received data on the display;
detecting a direction of a user's gaze;
causing an adjustment of the displayed data based on the detected direction; and
transmitting the adjustment to the device to be controlled.

17. The system of claim 16, wherein:
the direction of the user's gaze is one of a sequence of gaze directions;
the device to be controlled is a door; and
the method further comprises:
receiving, by the device to be controlled, the sequence of gaze directions;
comparing, by the device to be controlled, the sequence of gaze directions to a predetermined sequence of gaze directions; and
based on the sequence of gaze directions matching the predetermined sequence of gaze directions, unlocking the door.

18. The system of claim 16, wherein:
the device to be controlled is a thermostat; and
the operations further comprise:
receiving, by the thermostat, the adjustment; and
in response to receiving the adjustment changing a temperature of the thermostat.

19. The system of claim 16, wherein the operations further comprise:
receiving data from the device to be controlled; and
presenting, on the display, the received data.

20. A machine-readable storage medium storing instructions which, when executed by one or more processors, cause the one or more processors to perform operations comprising:
determining that a user's eyes cannot be detected by an eye-tracking sensor;
determining a direction of motion of the eye-tracking sensor suitable for allowing the user's eyes to be detected by the eye-tracking sensor; and
displaying an indicator of the direction of motion.
